(19) United States
(12) Patent Application Publication
(10) Pub. No.: US 2020/0275622 A1
(43) Pub. Date: Sep. 3, 2020

(54) System And Method For Forced Induction By Condensation On Plant Roots Using Temperature And Pressure

(71) Applicant: Joshua David Elliott, Chicago, IL (US)

(72) Inventor: Joshua David Elliott, Chicago, IL (US)

(21) Appl. No.: 16/289,538

(22) Filed: Feb. 28, 2019

(51) Int. Cl. A01G 31/02; A01G 29/00; A01G 7/04

(52) U.S. Cl. CPC A01G 31/02; A01G 7/045; A01G 29/00

(57) ABSTRACT

A plant growing system and method that uses a chamber having a plurality of holes through which plant stalks can extend. A heating device in fluid communication with the chamber is configured to receive a liquid nutrient solution from the chamber, to vaporize the received liquid nutrient solution to create a nutrient vapor, and to supply the nutrient vapor to the chamber to create a first pressure inside the chamber that is greater than a second pressure immediately outside the chamber. The increased vapor pressure on the roots of the plants relative to the leaves of the plants accelerates plant growth.

### FIELD OF THE INVENTION

The present invention relates generally to the field of hydroponics and aeroponics, and more specifically to an apparatus and method for the growing of plants and/or other organisms in a substantially water and air based environment.

### BACKGROUND OF THE INVENTION

Plant roots require three main inputs for healthy growth: air, water, and nutrients. As long as these inputs are adequately provided, the root system does not need to be placed in soil to thrive. The growing of plants in a nutrient rich water based solution is known as hydroponics. The growing of plants in a nutrient rich air and mist environment is known as aeroponics.

Such physical soil-less systems typically house the plant and provide its roots with a nutrient solution, water, and air. Using such a system aids growth due to the ability to optimize the provision of water, air, and nutrients to the roots. Another advantage of such systems is the ability to have greater control over pathogens and other microorganisms, either in terms defense or in terms of introducing beneficial microorganisms to encourage symbiosis or neutrality. Such systems also can provide greater flexibility over the location of the plant growth, either in terms of indoor versus outdoor, smaller quarters, and/or places with unusable soil.

A system using a nutrient solution in a fluid stage can be better controlled to balance nutrients, oxygen and other conditions, such that improved growth characteristics can be obtained compared to soil-grown plants. With soil-less methods, dense and fine root structures can be developed by the plant, thereby optimizing and facilitating transport through the xylem. Moreover, the addition of adequate oxygen to a nutrient solution or the use of aerosol prevents the respiratory death of cells in the root and prevents root rot and pathogenesis, by maintaining healthy root immune systems.

A primary concern with many commercial and domestic hydroponic and aeroponic applications is maximizing plant growth in the shortest time possible. In order to achieve this aim, various systems have been developed attempting to optimize uptake of the nutrient solution into the plant. However, such systems are complex, noisy, require frequent filter changes, require extensive maintenance, include many moving parts that tend to break, utilize nozzles that clog, require repeated cleaning, and require constant timing adjustments. These systems are not user friendly, lack longevity, and are excessively costly to make, store, transport, set up, and operate. Still other systems attempt to use heat from ultrasonic units which tend to be too much for the roots and system components to handle. Temperature control devices used to remove heat from such systems tend to expend it in a fashion that is wasted.

It is therefore an object of the present invention to solve the aforementioned problems and to provide an aeroponic system which is simpler to manufacture, transport and store, easier to use, requires less maintenance, consists of fewer moving parts, does not use nozzles that clog, minimizes required maintenance, and avoids using filters that require periodic changing. It is a further object of the invention to optimize the water/root interface, increase transpiration of leaves, and recapture the water from the plants for the purpose of water re-use and conservation.

### BRIEF SUMMARY OF THE INVENTION

The aforementioned problems and needs are addressed a plant growing system that includes a chamber having a plurality of holes through which plant stalks can extend, a heating device in fluid communication with the chamber and configured to receive a liquid solution from the chamber, to vaporize the received liquid solution to create a vapor, and to supply the vapor to the chamber to create a first pressure inside the chamber that is greater than a second pressure immediately outside the chamber.

A method of growing plants includes providing a chamber having a plurality of holes, providing plants each having a stalk extending through one of the holes, wherein each of the plants has roots disposed inside of the chamber and leaves disposed outside of the chamber, vaporizing a liquid solution using a heating device to create a vapor, and supplying the vapor to the chamber to create a first pressure inside the chamber that is greater than a second pressure immediately outside the chamber.

Other objects and features of the present invention will become apparent by a review of the specification, claims and appended figures.

### BRIEF DESCRIPTION OF THE DRAWINGS

FIG. 1 is a schematic view of the plant growing system of the present invention.

FIG. 2 is a side cross-sectional view of the growing chamber of the present invention.

FIG. 3 is a perspective view of the growing chamber of the present invention.

FIG. 4 is a side view of the growing chamber of the present invention.

FIG. 5 is a side view of the growing chamber of the present invention with the input lines.

FIG. 6 is a partial, exploded side view of the top of one of the cylindrical sub-chambers.

FIG. 7 is a side view of the top of one of the cylindrical sub-chambers.

FIG. 8 is a side cross-sectional view of the growing chamber of the present invention, illustrating the vapor in the sub-chambers and liquid nutrient solution in the main chamber.

FIG. 9 is a side view of the top of one of the cylindrical sub-chambers with a UV light source.

### DETAILED DESCRIPTION OF THE INVENTION

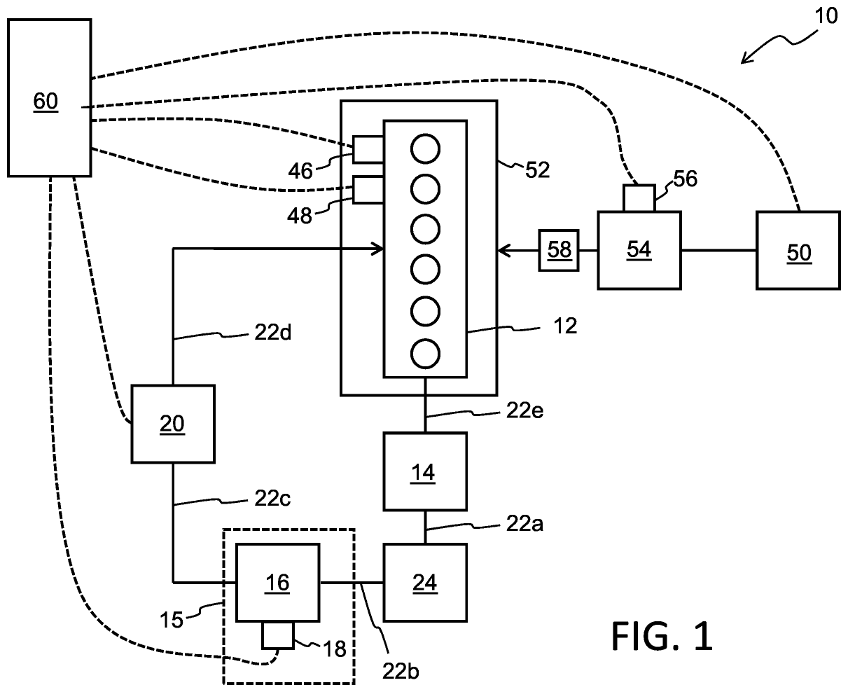

The present invention is a plant growing system 10 as shown in FIG. 1. The system 10 includes a growing chamber 12, a reservoir 14, a heating device 15, and valve 20, all interconnected as shown with lines 22a-22e. Lines 22a-22e can be flexible tubing, rigid pipes, or a combination of the two.

Reservoir 14 is a container that holds a water based nutrient solution. As a non-limiting example, the nutrient solution can include the following (per gallon of water base): 6.0 gram of Ca(NO3)2, 2.09 grams KNO3, 0.46 grams K2SO4, 1.39 grams KH2PO4, 2.42 grams MgSO4 7H20, and 0.4 grams of 7% Fe Chelated trace elements (where Fe Chelated trace elements can include 7% iron, 2% manganese, 0.4% zinc, 0.1% copper, 1.3% boron and 0.06% molybdenum).

The nutrient solution passes from reservoir 14, through line 22a, through a back flow preventer valve 24 (which prevents any reverse flow of the nutrient solution), through line 22b, and into heating device 15. The heating device 15 preferably includes a chamber 16 for receiving the nutrient solution, and a heating element 18 that provides sufficient heat to vaporize the received nutrient solution to create a heated nutrient vapor (mist). A non-limiting example for heating element 18 is a glow plug (similar to those used in diesel engines) or its equivalent, which provides heat up to 1200 degrees Celsius. Preferably, heating element 18 generates a nutrient vapor that is preferably heated to at least 800 degrees Celsius for several reasons. First, that temperature is the minimum temperature required to liquefy the salt component of the nutrient solution, and to prevent the salt component from accumulating on apparatus surfaces inside the system as it is delivered to the roots of the plants. Second, this high temperature efficiently generates vapor molecules of the various nutrients in solid or liquid form suspended in water vapor) allowing greater control of micron droplet formation, which is ideal for root absorption as further described below. This is in contrast with vapor generation techniques such as ultrasound, which typically generates mist molecules around 5 microns in size (which are too small). Third, the high temperature serves to self-clean the system because it effectively kills contaminants. Fourth, this temperature effectively generates the positive pressure necessary to drive the nutrient vapor through line 22c, through valve 20, through line 22d, and into growing chamber 12, and to positively pressurize growing chamber 12 as further explained below. The flow of the nutrient vapor and therefor the pressure inside grow chamber 12 can be controlled by valve 20.

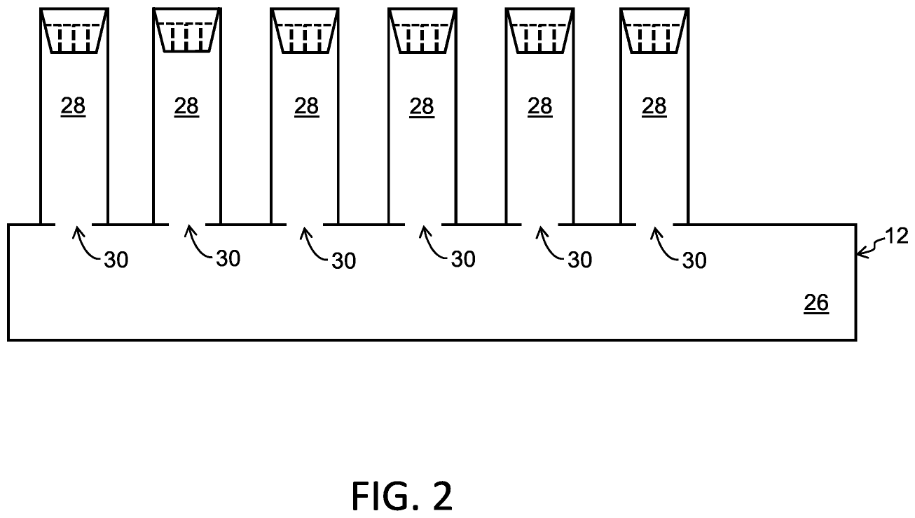

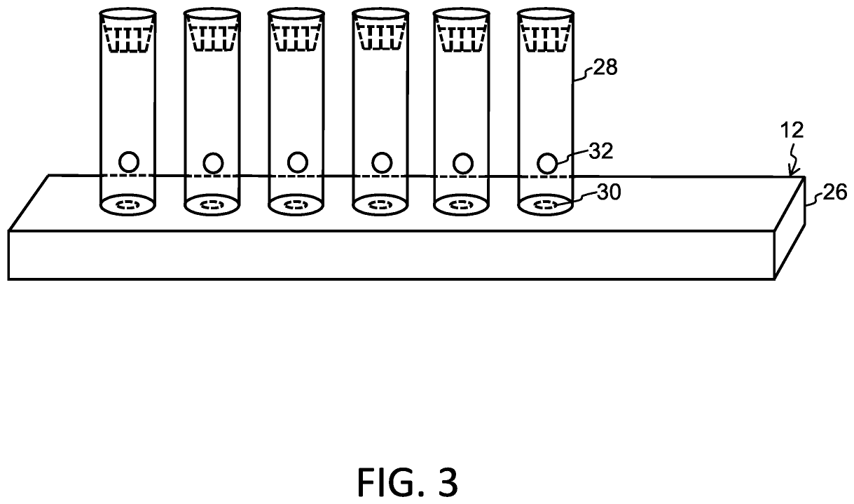

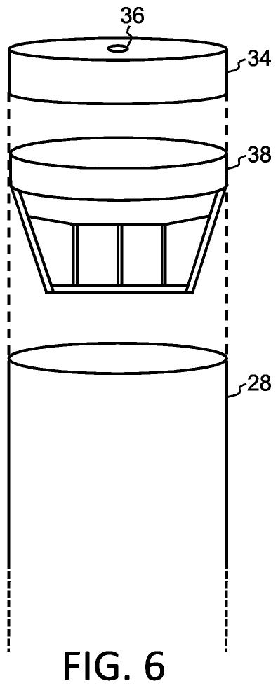

Growing chamber 12 is best shown in FIGS. 2-6, and includes a main chamber 26 and a plurality of sub-chambers 28 extending up from and in fluid communication with the main chamber 26. See FIGS. 2-3. In a non-limiting embodiment shown in the figures, main chamber 26 is rectangular shaped, and each sub-chamber 28 is a cylinder extending up from the top of main chamber 26 and in fluid communication therewith via openings 30. Main chamber 26 and sub-chambers 28 collectively form a sealed growing chamber 12.

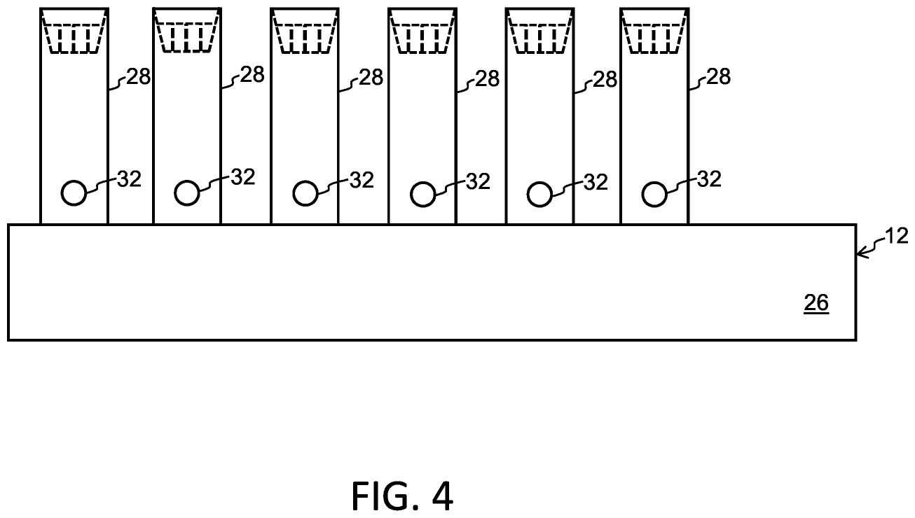

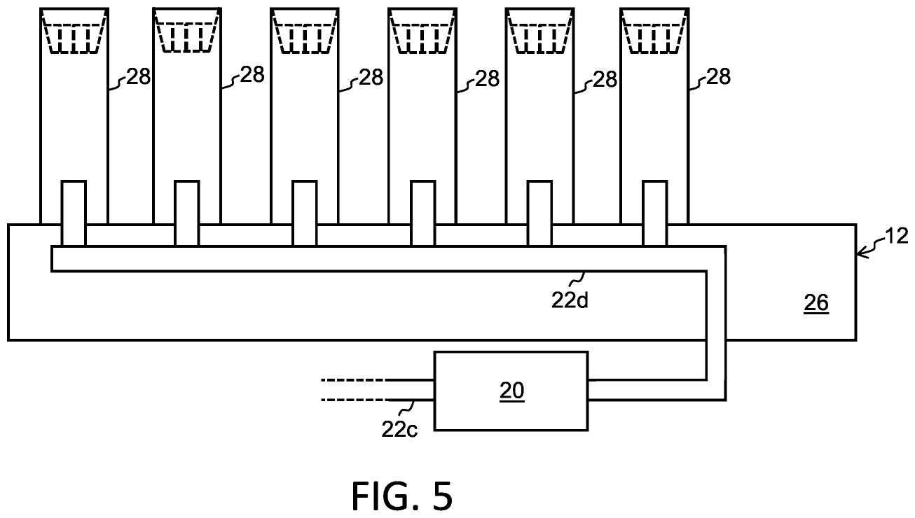

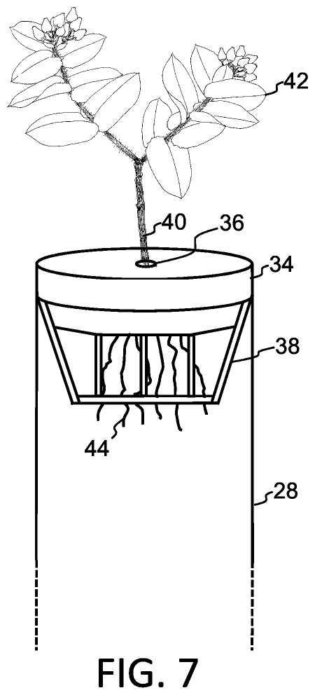

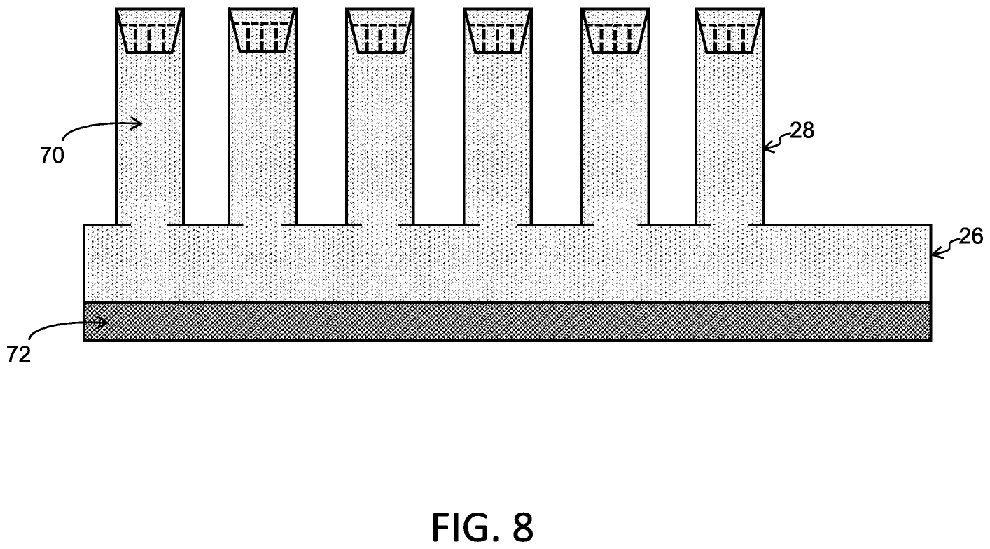

Each sub-chamber 28 includes an opening 32 (see FIGS. 3-4) in its side wall to which the line 22d connects (see FIG. 5), so that the nutrient vapor is supplied directly to each of the sub-chambers 28. The top of each sub-chamber 28 include a membrane 34 installed therein that seals the top of the sub-chamber 28. The membrane 34 is preferably made of neoprene or any other appropriate material that absorbs, blocks and/or otherwise prevents the nutrient vapor from escaping the sub-chamber 28, but preferably does allow air to flow there through by stripping the nutrient molecules from the air passing there through). Membrane 34 can include a small hole 36 through which the plant will grow. The hole 36 will preferably expand with plant growth, and therefore make an air seal with the plant stalk. Underneath the membrane 34 is a root cage assembly 38 that provides a cage structure to physical support of the roots of the plant. FIG. 7 shows a plant with its stalk 40 growing through hole 36 of membrane 34, its leaf structure 42 above membrane 34 and outside of sub-chamber 28, and its root structure 44 below membrane 34 and inside of sub-chamber 28. As used herein, the area immediately above the membrane 34 outside the sub-chamber 28 is referred to as the leaf zone (where the plant's leaf structure 42 grows), and the area immediately below the membrane 34 inside the sub-chamber 28 is referred to as the root zone (where the plant's root structure 44 grows). As shown in FIG. 8, condensation of the nutrient vapor 70 back into a nutrient solution 72 is captured by the main chamber 26, where the nutrient solution is then fed back to the reservoir 14 by line 22e so the nutrient solution can be vaporized again into a nutrient vapor for re-insertion into the sub-chambers 28.

The growing chamber 12 includes one or more temperature sensors 46 to measure the temperature of the nutrient vapor inside the growing chamber 12, and preferably inside one or more of the sub-chambers 28 of the growing chamber 12. The growing chamber 12 also includes a pressure sensor 48 to measure the pressure inside the growing chamber 12.

An air pump 50 provides a cooling air flow for the growing chamber 12. The cooling air flow can be simply blown on the growing chamber 12 to cool the nutrient vapor and/or nutrient solution therein. An optional secondary chamber 52 can be positioned around the growing chamber 12 to contain the cooling air around the growing chamber 12. An optional cooling chamber 54 and cooling element 56 can be used to cool the air flow from pump 50. One example of the cooling element 56 is a thermoelectric cooler (TEC). An optional air valve 58 can be used to control the amplitude of the air flow onto the growing chamber 12. By providing a separate sub-chamber 28 for each plant, a greater cooling effect and efficiency can be achieved (by increasing the surface area of the growing chamber 12 portion dedicated to each plant).

A controller 60 containing control circuitry is connected to the various system components for monitoring and control. Specifically, the controller 60 receives the outputs of temperature sensor 46 and pressure sensor 48, and controls the operation of the heat element 18 and valve 20, the air pump 50, cooling element 56 and valve 58 in response, to achieve and maintain the desired temperature and pressure inside the growing chamber 12.

It has been discovered by the present inventor that providing the nutrient vapor to the root zone at a pressure greater than 1 atmosphere (1 ATM) accelerates the growing process of most plants. Specifically, maintaining the root zone of the growing chamber 12 to a pressure of approximately 0.5 PSI to 5 PSI above 1 ATM, with the leaf zone at 1 ATM, causes a forced induction of the water and nutrients in the nutrient vapor into the roots, accelerating plant growth. The pressure differential of 0.5 PSI to 5 PSI between the root zone and the leaf zone is easiest to achieve by providing a pressure above 1 ATM at the root zone, and a 1 ATM pressure at the leaf zone, so there is no need for a pressure chamber or other apparatus for holding the leaf zone at a pressure other than 1 ATM. However, the pressure differential could optionally be achieved at least partially by manipulating the pressure at the leaf zone to something other than 1 ATM.

It has also been discovered that the temperature of the root zone significantly affects the rate at which the roots absorb the water based nutrients. It has been determined that the ideal temperature of the root zone for most blooming plants is approximately 75 degrees Celsius, and for most non-blooming plants is approximately 67 degrees Celsius, both of which are well below the initial vapor temperature of 800 degrees Celsius or more. These ideal temperatures can vary not only based on the particular plants being grown, but also with the differential pressure used in operation between the root and leaf zones. Therefore, cooling of the growth chamber 12 is preferable to maintain these root zone temperatures. Separate sub-chambers for different plants provides more efficient conduction cooling (i.e., increased growth chamber surface area for each root zone for increased heat conduction). While ambient cooling using still air may be possible, using circulating cooling air (from pump 50) to extract the necessary heat from the system to achieve and maintain the desired root zone temperatures is advantageous for those applications that would otherwise require placing the leaf zone in a frigid ambient air temperature that is not ideal for plant growth. Moreover, the circulating air can be used to transfer the heat from the root zone to the leaf zone, further promoting plant growth.

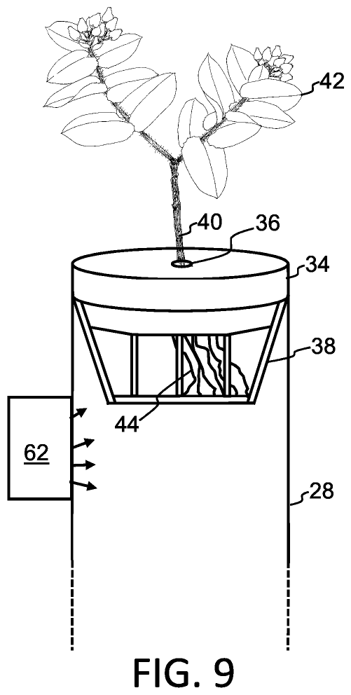

FIG. 9 illustrates the addition of an optional UV light source 62 attached to the sub-chamber 28 for illuminating the root zone with UV light. The UV light promotes root growth and directionality of growth. Preferably, the UV light source 62 is activated in intervals of 15 minutes or less. When the roots are exposed to UV light, they begin “escape tropism,” which caused the plant to focus its energy on growing the roots away from the light. Therefore, in the present case, the UV light will cause the plants to grow in a ordered fashion. The UV light can be used to better utilize space in the root zone. For example, when growing plants with large roots, the UV light source could be placed below the roots to keep them from overtaking the bottom of the sub-chamber 28 and the main chamber 26, and instead force the roots to grow and crowd a smaller space adjacent the top of the sub-chamber 28.

The present invention has many advantages. The system provides pressure enhanced fusing of water, nutrients and air into roots, greatly increasing plant growth rates and allowing crop harvest in shorter growing cycles. The air flowing through membrane 34 (without accompanying water and nutrients which are blocked) is beneficial to the leaves in the leaf zone, increases the transpiration process. Providing a separate sub-chamber 28 for each plant means that vapor flow, temperature, air flow and even pressure can be customized dependent on plant type and/or growth cycle.

The system and method of the present invention provides a platform for rapid crop growth with a small form factor, allowing for indoor use in otherwise harsh climates. The system can be used in more seasons and in locations closer to consumer markets (reducing shipping costs and time, and allowing produce to be both locally grown and consumed). The size of the system and its crop production can be effectively scaled in size to meet the needs of the user (individual residential use versus industrial applications). The system is self-cleaning and requires relatively little maintenance. The system produces little noise given that the vapor pressure is generated by the same heat source used to vaporize the nutrient solution, making it ideal for indoor and residential use. The use of liquid or vapor pumps, liquid filters, and oxygenating systems required by typical hydroponic devices is avoided. Also avoided is the use of mist or vapor jets, which can clog and require routine maintenance.

The system provides pressurized nutrient vapor at the root zone with a range of ideal molecule sizes (e.g., 40 to 80 microns). Roots with a smaller size provide less surface area for vapor condensation, so molecules at the lower end of the size range condense onto and are driven into the root. As roots grow to larger sizes, they provide a larger surface area so that molecules at the higher end of the size range condense onto and are driven into the root. Therefore, the roots self-select the ideal molecule size given the root's size, enhancing growth. In addition to this self-selection, the controller 60 can be programmed to modify pressure and/or temperature conditions over the growing cycle of the plants, to fine tune the molecule condensation and infusion. For example, the pressure and/or temperature in the root zone can be changed as the roots change in size or consistency as they grow (e.g., stringy versus hairy) to maximize vapor condensation on and infusion into the roots.

It is to be understood that the present invention is not limited to the embodiment(s) described above and illustrated herein, but encompasses any and all variations falling within the scope of any claims. For example, references to the present invention herein are not intended to limit the scope of any claim or claim term, but instead merely make reference to one or more features that may be covered by one or more of the claims. Materials, processes and numerical examples described above are exemplary only, and should not be deemed to limit the claims. Certain components could be combined for simplicity or reduced cost. For example, the reservoir 24 can be eliminated, whereby the bottom of the grow chamber 12 can be used to hold the nutrient solution that is fed to the heating element. The cooling chamber 54 and cooling element 56 can be eliminated for those applications in which the source of air for pump 50 is already sufficiently cool (e.g., cold air climates). Valve 20 can be a plurality of valves (one for each sub-chamber 28 for individual control either manually or by the controller), or can be eliminated for those applications in which adequate flow and pressure control is attainable from the heating device 15.

What is claimed is:

1. A plant growing system, comprising:
a chamber having a plurality of holes through which plant stalks can extend;
a heating device in fluid communication with the chamber and configured to receive a liquid solution from the chamber, to vaporize the received liquid solution to create a vapor, and to supply the vapor to the chamber to create a first pressure inside the chamber that is greater than a second pressure immediately outside the chamber.

2. The plant growing system of claim 1, wherein the chamber includes a plurality of sub-chambers, wherein each of the sub-chambers includes one of the holes.

3. The plant growing system of claim 2, wherein for each of the sub-chambers, the hole is formed in a membrane of material that passes an air component of the vapor but absorbs or blocks a liquid component of the vapor.

4. The plant growing system of claim 3, wherein the membranes are formed of neoprene.

5. The plant growing system of claim 1, wherein each of the sub-chambers includes a cage structure inside the sub-chamber and adjacent to the hole.

6. The plant growing system of claim 1, wherein the heating device is configured to heat the vapor to at least 800 degrees Celsius.

7. The plant growing system of claim 1, further comprising:
a first line providing a first fluid communication between the chamber and the heating device;
a second line providing a second fluid communication between the chamber and the heating device;
wherein the heating device is configured to receive the liquid solution from the first line and supply the vapor to the second line.

8. The plant growing system of claim 7, further comprising:
a reservoir disposed along the first line for holding the liquid solution from the chamber.

9. The plant growing system of claim 1, wherein the first pressure is 0.5 to 5.0 PSI greater than the second pressure.

10. The plant growing system of claim 1, further comprising:
an air pump for generating an air flow along one or more outer surfaces of the chamber; and
a cooling device for cooling the air flow generated by the air pump.

11. The plant growing system of claim 1, further comprising:
a temperature sensor configured to measure a temperature inside the chamber;
a pressure sensor configured to measure a pressure inside the chamber;
a controller for controlling an operation of the heating device in response to output signals from the temperature sensor and the pressure sensor.

12. The plant growing system of claim 10, further comprising:
a temperature sensor configured to measure a temperature inside the chamber;
a pressure sensor configured to measure a pressure inside the chamber;
a controller for controlling an operation of the heating device, and an operation of the cooling device or the air pump, in response to output signals from the temperature sensor and the pressure sensor.

13. The plant growing system of claim 1, further comprising:
a UV light source for illuminating an inside of the chamber with UV light.

14. A method of growing plants, comprising:
providing a chamber having a plurality of holes;
providing plants each having a stalk extending through one of the holes, wherein each of the plants has roots disposed inside of the chamber and leaves disposed outside of the chamber;
vaporizing a liquid solution using a heating device to create a vapor;
supplying the vapor to the chamber to create a first pressure inside the chamber that is greater than a second pressure immediately outside the chamber.

15. The method of claim 14, wherein the vaporizing creates the vapor having a temperature of at least 800 degree Celsius.

16. The method of claim 14, wherein the first pressure is 0.5 to 5.0 PSI greater than the second pressure.

17. The method of claim 14, further comprising:
generating an air flow along one or more outer surfaces of the chamber, and cooling the air flow.

18. The method of claim 14, further comprising:
measuring a temperature inside the chamber;
measuring a pressure inside the chamber;
modifying the vaporizing in response to the measuring of the temperature and the measuring of the pressure.

19. The method of claim 17, further comprising:
measuring a temperature inside the chamber;
measuring a pressure inside the chamber;
modifying the vaporizing, and the generating the air flow or the cooling, in response to the measuring of the temperature and the measuring of the pressure.

20. The method of claim 14, further comprising:
illuminating the plant roots with UV light.
